(19) United States
(12) Patent Application Publication
(10) Pub. No.: US 2026/0100024 A1
(43) Pub. Date: Apr. 9, 2026

(54) IMAGE RECOGNITION DEVICE, IMAGE RECOGNITION METHOD, AND PROGRAM

(71) Applicant: Panasonic Intellectual Property Management Co., Ltd., Osaka (JP)

(72) Inventors: Tomoaki ITOH, Tokyo (JP); Hidehiko SHIN, Osaka (JP); Akihiro TANAKA, Osaka (JP)

(21) Appl. No.: 19/416,438

(22) Filed: Dec. 11, 2025

Related U.S. Application Data
(63) Continuation of application No. PCT/JP2024/016541, filed on Apr. 26, 2024.

(30) Foreign Application Priority Data
Jun. 13, 2023 (JP) 2023-097090

(51) Int. Cl. G06V 10/764; G06V 40/10

(52) U.S. Cl. CPC G06V 10/764; G06V 40/103

(57) ABSTRACT

An image recognition device includes a memory that stores image data in which an image of a work region is captured by a camera; and arithmetic circuitry that performs a classification of an action of a worker based on the image data. The classification includes a first class, a second class different from the first class, a first subclass and a second subclass included in the first class, the second subclass being different from the first subclass. The arithmetic circuitry switches a granularity of the first class when assigning the action of the worker to the classification, based on information in the work region in the image indicated by the image data.

### TECHNICAL FIELD

The present disclosure relates to an image recognition device, an image recognition method, and a program using a machine learning model and/or an image recognition algorithm.

### BACKGROUND ART

JP 7010542 B2 discloses a device for analyzing work performed by a worker on an object. A work analysis device of JP 7010542 B2 specifies the position of a hand of the worker and the position of the object, calculates a distance between the hand of the worker and the object, and specifies a content of a motion performed by the worker based on the calculated distance.

### SUMMARY

The present disclosure provides an image recognition device, an image recognition method, and a program capable of effectively classifying an action of a worker in accordance with an imaging situation of image data.

An image recognition device according to an aspect of the present disclosure includes: a memory that stores image data in which an image of a work region is captured by a camera; and arithmetic circuitry that performs a classification of an action of a worker based on the image data, wherein the classification includes a first class, a second class different from the first class, a first subclass and a second subclass included in the first class, the second subclass being different from the first subclass, and the arithmetic circuitry switches a granularity of the first class when assigning the action of the worker to the classification, based on information in the work region in the image indicated by the image data.

An image recognition method according to an aspect of the present disclosure includes: acquiring, by arithmetic circuitry, image data in which an image of a work region is captured by a camera; performing, by the arithmetic circuitry, a classification of an action of the worker based on the image data, wherein the classification includes a first class, a second class different from the first class, a first subclass and a second subclass included in the first class, the second subclass being different from the first subclass, and wherein the method further comprising switching, by the arithmetic circuitry, a granularity of the first class when assigning the action of the worker to the classification, based on information in the work region in the image indicated by the image data.

A non-transitory computer-readable storage medium according to an aspect of the present disclosure stores a program for causing arithmetic circuitry to execute the image recognition method described above.

The present disclosure can effectively classify a content of the action of the worker in accordance with an imaging situation of the image data.

### BRIEF DESCRIPTION OF DRAWINGS

FIG. 1 is a schematic diagram illustrating an outline of a work classification system according to a first embodiment of the present disclosure;

FIG. 2 is a schematic diagram illustrating an example of an image indicated by image data generated by a camera in FIG. 1;

FIG. 3 is a block diagram illustrating a configuration example of a work classification device in FIG. 1.

FIG. 4 is a graph illustrating an example of a classification result of action contents by the work classification device according to the first embodiment;

FIG. 5 is a flowchart illustrating an example of an operation of the work classification device of FIG. 1;

FIG. 6 is a flowchart illustrating details of work classification processing illustrated in FIG. 5;

FIG. 7 is a table illustrating an example of a classification result DB in FIG. 3;

FIG. 8 is a schematic diagram illustrating an example of a display image illustrating a classification result by the work classification processing illustrated in FIG. 5;

FIG. 9 is a schematic diagram illustrating an example of an image indicated by image data generated by a camera in a second embodiment;

FIG. 10 is a flowchart illustrating an example of work classification processing according to the second embodiment; and

FIG. 11 is a table illustrating an example of a modification of the classification result DB.

### DETAILED DESCRIPTION

Hereinafter, embodiments will be described with reference to the drawings as appropriate. However, unnecessarily detailed description may be omitted. For example, detailed description of well-known matters and duplicate description of substantially the same configuration may be omitted. This is to avoid unnecessary redundancy in the following description and to facilitate understanding by those skilled in the art.

It should be noted that the accompanying drawings and the following description are provided by the inventors for those skilled in the art to fully understand the present disclosure, and are not intended to limit the subject matter described in the claims.

### 1. First Embodiment

### 1-1. Outline

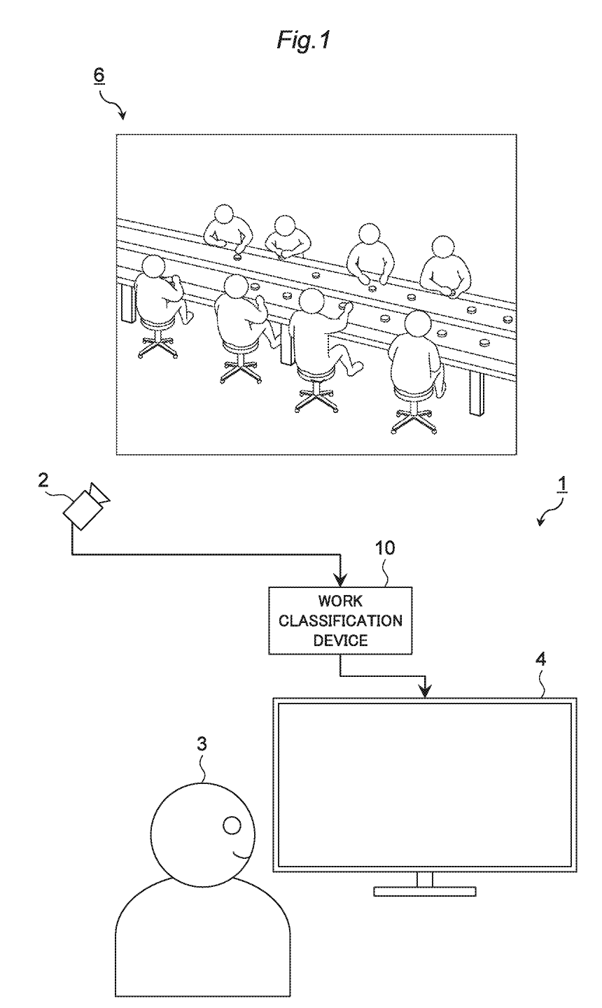

FIG. 1 is a schematic diagram illustrating an outline of a work classification system 1 according to a first embodiment of the present disclosure.

The work classification system 1 includes a camera 2 and a work classification device 10. The work classification system 1 is applied to a purpose of classifying a content of a motion of a worker who performs work such as line work in a workplace 6 such as a factory. The work classification system 1 includes a display 4 for presenting the result of classifying the tasks performed by the worker to a user 3 such as a manager of the workplace 6 or a person in charge of analysis.

The camera 2 is positioned to capture a worker performing work in the workplace 6. The camera 2 captures an image of the workplace 6 at a predetermined cycle, for example, and generates image data indicating the captured image. Although only one camera 2 is illustrated in FIG. 1, the number of the cameras 2 included in the work classification system 1 is not limited to one, and may be two or more. For example, the camera 2 may capture a moving image of the workplace 6 and generate moving image data indicating the captured moving image.

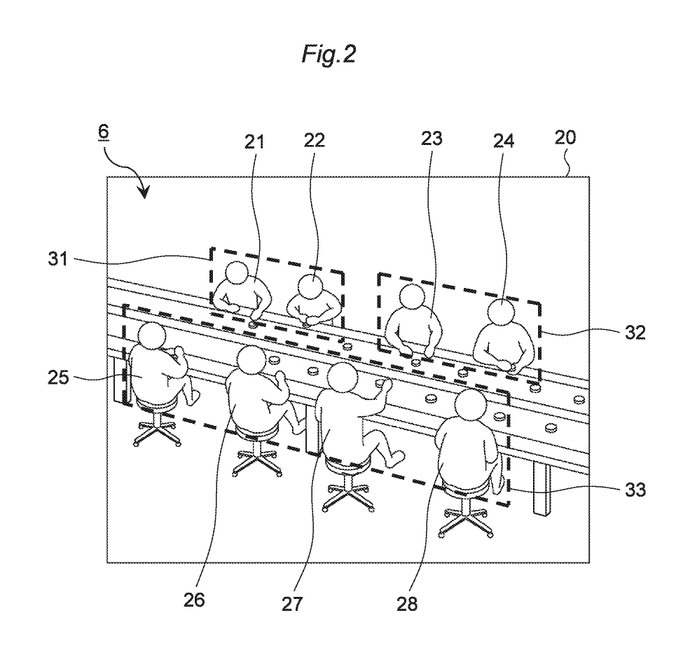

FIG. 2 is a schematic diagram illustrating an example of an image 20 indicated by image data generated by the camera 2. The image 20 shows the workplace 6. In the workplace 6, eight workers 21 to 28 are working. FIG. 2 illustrates three work areas 31 to 33. For example, the work areas 31 to 33 are determined in advance as predetermined regions in the image 20. The position, size, and the like of the work areas 31 to 33 can be arbitrarily set by the user 3, for example. The actual workplace 6 may be provided with areas corresponding to the work areas 31 to 33 on the image.

An assigned area of the workers 21 and 22 is the work area 31. The assigned area is determined in advance as an area where the worker performs work. At least one assigned area is defined for each person in charge. The assigned area of the workers 23 and 24 is the work area 32. The assigned area of the workers 25 to 28 is the work area 33. Unlike the example illustrated in FIG. 2 in which each work area includes a plurality of workers, the work areas and the workers may be associated one-to-one.

### 1-2. Configuration of Work Classification Device

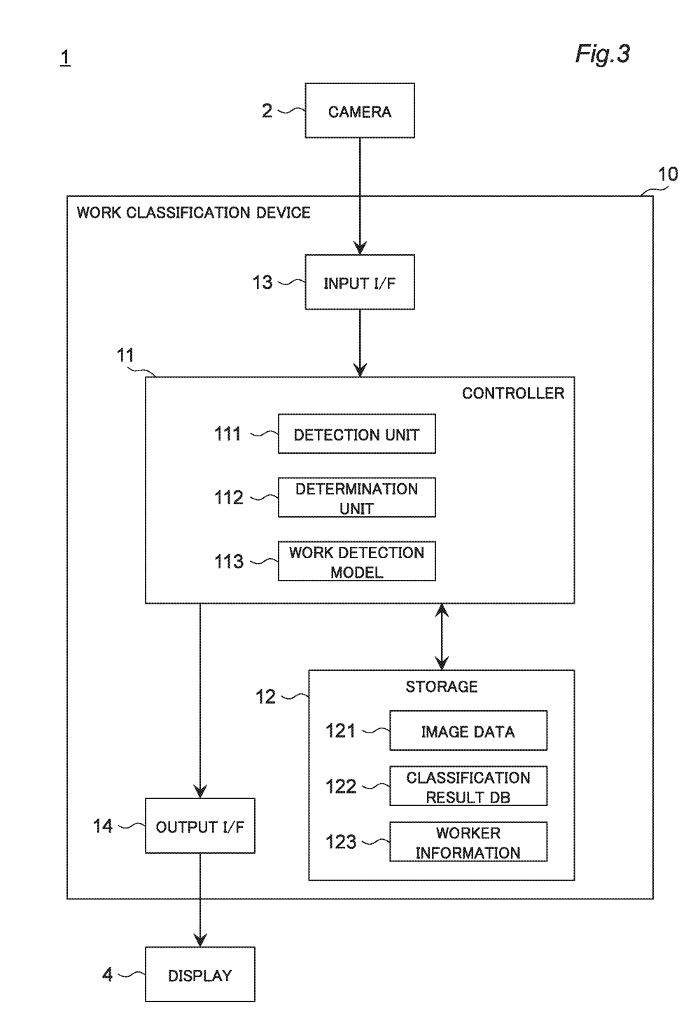

FIG. 3 is a block diagram illustrating a configuration example of the work classification device 10. The work classification device 10 includes a controller 11, a storage 12, an input interface (I/F) 13, and an output interface 14.

The controller 11 includes, for example, a processor, an arithmetic circuit, and/or arithmetic circuitry that implements a predetermined function in cooperation with software, and controls an overall operation of the work classification device 10. The controller 11 reads data and programs stored in the storage 12, performs various types of operation processing, and implements various functions. For example, the controller 11 operates as a detection unit 111 and a determination unit 112.

The controller 11 may be a hardware circuit such as a dedicated electronic circuit designed to implement a predetermined function or a reconfigurable electronic circuit. The controller 11 may include various semiconductor integrated circuits such as a CPU, an MPU, a GPU, a GPGPU, a TPU, a microcomputer, a DSP, an FPGA, and an ASIC instead of the arithmetic circuitry or as the arithmetic circuitry. A work classification method according to the present embodiment may be executed by distributed computing.

The controller 11 includes a work detection model 113 that detects work of an object and a worker by image recognition processing.

The work detection model 113 is a learned model subjected to learning by a neural network such as a convolutional neural network. The work detection model 113 executes image recognition processing on the image indicated by the image data. The work detection model 113 outputs, as a detection result, a region in which an object such as a preset hand of a worker is shown in an image, for example. A detection target of the work detection model 113 in the present embodiment is set to a hand of the worker. The region output as the detection result is defined by, for example, a horizontal position and a vertical position on the image, and indicates a region surrounding the detection target in a rectangular shape.

In the present embodiment, when the work detection model 113 cannot recognize the region as a detection target in an image (that is, not detect a hand of the worker), the work detection model 113 outputs, for example, a null value as a detection result. The detection result may include, for example, information indicating the time when the image is captured. The work detection model 113 is obtained, for example, by performing supervised learning using training data in which images showing a worker’s hand are associated with ground truth labels.

The learned model of the work detection model 113 is not limited to the neural network, and may be another machine learning model related to image recognition. As the work detection model 113, an image recognition algorithm may be adopted instead of a model generated by machine learning. For example, the work detection model 113 may be configured to detect work by rule-based image recognition processing.

The storage 12 is a storage medium that stores various types of information including programs and data necessary for implementing the functions of the work classification device 10. For example, the storage 12 may be a non-transitory computer-readable storage medium. The storage 12 is implemented by, for example, a semiconductor storage such as a flash memory or a solid state drive (SSD), a magnetic storage such as a hard disk drive (HDD), or other storage medium alone or in combination thereof. The storage 12 is not limited to a built-in storage installed in the same casing as the controller 11, and may be, for example, an external storage, a network-attached storage (NAS) unit, or the like. The storage 12 may include a volatile memory such as a RAM.

The storage 12 stores image data 121 received from the camera 2, a classification result database (DB) 122 including a classification result by the work classification device 10, and worker information 123. The worker information 123 is, for example, a database in which identification information for identifying a plurality of workers is associated with a work area (assigned area) in which each worker is scheduled to perform work.

The input interface 13 is an example of an input unit that connects the work classification device 10 and the camera 2 in order to input information such as image data from the camera 2 to the work classification device 10. The input interface 13 may be a communication circuitry that performs data communication in accordance with an existing wired communication standard or wireless communication standard.

The output interface 14 is an example of an output unit that connects the work classification device 10 and an external device in order to output information such as a control signal, a video signal, and a work classification result from the controller 11 to the external device such as the display 4. The output interface 14 may be a communication circuitry that performs data communication in accordance with an existing wired communication standard or wireless communication standard. The output interface 14 may have a configuration similar to the configuration of the input interface 13.

The input interface 13 and the output interface 14 may be implemented as separate interfaces as in FIG. 3, but are not limited thereto. For example, the input interface 13 and the output interface 14 may be integrally configured.

### 1-3. Motion

### 1-3-1. Outline

In the image 20 shown in FIG. 2, the workers 21 and 22 in the work area 31 and the workers 23 and 24 in the work area 32 are captured at positions and orientations where their hands are easily visible. Whether the area in which a worker is located is one where the hands are easily captured depends on the positional and orientational relationship between the camera 2 and the worker. In this context, the work areas 31 and 32 are areas where the hands of workers are likely to be captured, whereas the work area 33 is an area where their hands are less likely to be captured.

A typically assumed work segmentation technique (hereinafter referred to as “the typical technique”) can identify the details of a worker’s actions with relatively high accuracy when the worker is in a work area where hands are easily captured. Alternatively, under the typical technique, the period during which the worker’s actions can be identified tends to be relatively long when the worker is in such an area. However, with the typical technique, if the position of the worker’s hands cannot be determined, the details of the worker’s actions cannot be accurately identified. Consequently, for workers in areas where their hands are less likely to be captured, the details of their actions cannot be sufficiently identified. Therefore, with the typical technique, it is not possible to evaluate what kind of work is being performed, or to assess work efficiency, particularly for workers in areas where their hands are less likely to be captured.

In order to make it possible to perform the evaluation as described above, for example, it is conceivable to arrange the worker or the camera so that the hands of all the workers easily appear, but it cannot be easily realized due to restrictions such as the structure of the work place, the arrangement condition of the worker, the condition of the installation place of the camera, and the number of available cameras.

Therefore, as a result of intensive research, the inventors have obtained an idea of changing the granularity of the classification of a content of an action of the worker in accordance with the imaging situation of the image data, and have reached the present disclosure. Here, the granularity of classification refers to how detailed the objects to be classified are. The granularity of classification may be the depth of the hierarchy of the class to be assigned, or may be a category having a different abstraction level.

For example, when an object such as a hand of the worker is shown in the image indicated by the image data, the work classification device 10 according to the present embodiment finely classifies the content of the action of the worker based on the detection result of the object.

On the other hand, when the object is not visible in the image, the inventors conceived the idea of classifying the worker’s actions at the highest possible level of granularity instead of giving up the classification altogether. The work classification device 10 according to the present embodiment lowers the classification granularity when the object is not visible in the image, as compared with when the object is visible, and enables classification of the worker’s actions to the extent possible. As a result, the work classification device 10 according to the present embodiment can obtain more classification information from the same amount of data than a technique that does not classify the worker’s actions when the object is not visible in the image. Therefore, the work classification device 10 according to the present embodiment can reduce the amount of data required to obtain the same amount of classification information, thereby reducing memory usage, computational load, and communication traffic associated with data exchange.

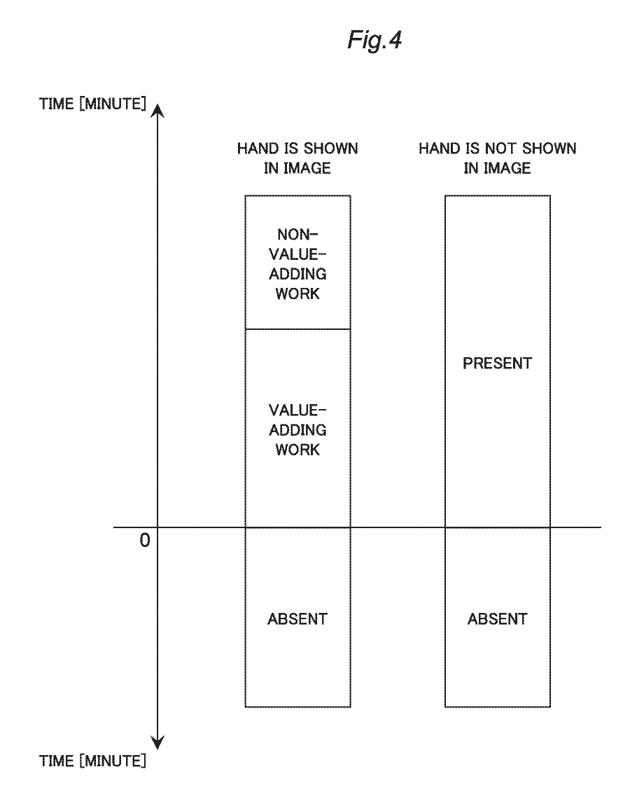

FIG. 4 is a graph illustrating an example of a classification result of action contents classified by work classification device 10 according to the present embodiment. A bar graph in FIG. 4 is a graph visualizing a classification result of action contents classified by the work classification device 10. The work classification device 10 determines whether the worker is in the assigned area (present) or not (absent).

In the present specification, the action of the worker includes not only the motion performed by the worker in the assigned area but also the fact that the worker is present in the assigned area and the fact that the worker is not present (is absent) in the assigned area.

When the hand of the worker, which is an example of the object, appears in the image and can be detected, the work classification device 10 determines whether the work being performed by the worker in the image is value-adding work or non-value-adding work. Value-adding work refers to a type of work that is predefined as a target of the classification processing performed by the work classification device 10. The value-adding work represents one example of the target work of the present disclosure.

Non-value-adding work refers to actions of the worker other than value-adding work. The actions of the worker include both actions (or commission) and inactions (or omission). For example, the worker is considered to be engaged in non-value-adding work when the worker is actively performing motions other than value-adding work, or when the worker is standing still.

By performing the processing as described above, the work classification device 10 can generate a work classification result as in a bar graph on the left side of FIG. 4 when an object such as a hand of the worker is shown in the image.

On the other hand, even in a case where the object is not shown in the image, the work classification device 10 can generate a work classification result as in a bar graph on the right side of FIG. 4. As described above, the work classification device 10 reduces the granularity of classification when the object is not shown in the image as compared with a case where the object is shown in the image. In a case where the object is not shown in the image, it does not mean that the work classification device 10 does not classify the content of the action of the worker, but although reducing the granularity, the work classification device 10 makes it possible to classify the content of the action of the worker to the extent. Here, a subclass with a reduced granularity of the class “present” corresponds to the value-adding work or the non-value-adding work. "Present" is a higher-order category of the value-adding work or the non-value-adding work, and is a higher-order concept.

In an image captured for a predetermined period, for example, on a specific day (for example, 24 hours), the work classification result for one day regarding a specific worker is usually a result in which a classification result when a hand is shown as in the bar graph on the left side of FIG. 4 and a classification result when a hand is not shown as in the bar graph on the right side of FIG. 4 are mixed.

In the work classification device 10 according to the present embodiment, even in a case where the worker sets an area where a hand is less likely to appear as an assigned area, it is possible to know at least time during which the worker has been in the assigned area. In a case where there is a period in which a hand is shown, the work classification device 10 can further know value-adding work time and non-value-adding work time during the period.

By analyzing such a work classification result or by viewing the work classification result displayed on the display 4, the user 3 can know the work content (action) of the worker with the highest possible granularity in accordance with the imaging situation. The user 3 can evaluate the work content of each worker based on such knowledge. By feeding back such evaluation to the worker himself/herself, a labor system, or the like, it is possible to improve the efficiency of the work performed in the workplace 6.

The user 3 can improve the efficiency of the work performed in the workplace 6 by reviewing the system such as the arrangement of things and the arrangement of people in the workplace 6 based on the above knowledge.

### 1-3-2. Overall Operation

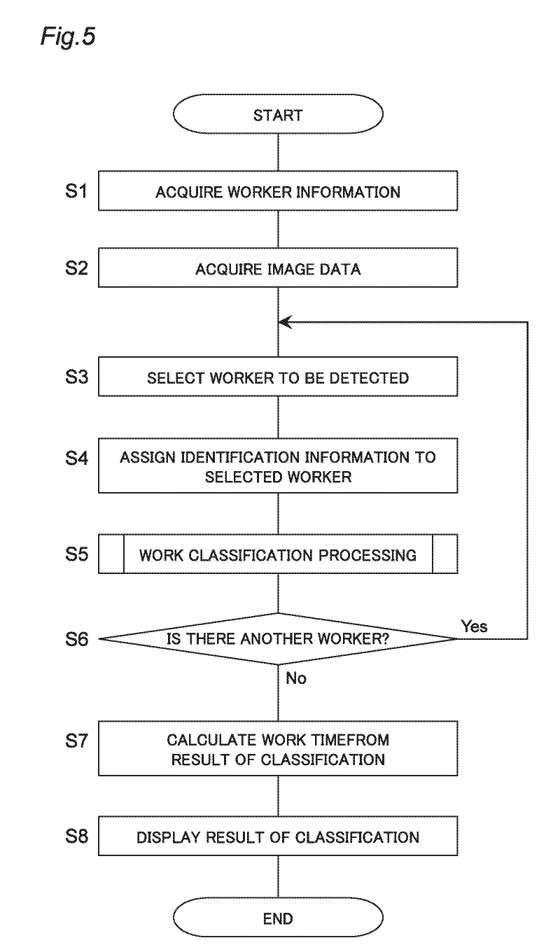

FIG. 5 is a flowchart illustrating an example of an operation of the work classification device 10. Each processing illustrated in this flowchart is executed by, for example, the controller 11 of the work classification device 10.

The controller 11 acquires the worker information 123 (S1). The controller 11 may acquire the worker information 123 from the outside via the input interface 13, or may acquire the worker information 123 stored in advance in the storage 12.

The controller 11 acquires image data from the camera 2 via the input interface 13 (S2). The controller 11 stores the acquired image data 121 in the storage 12. Unlike the example of FIG. 5, step S2 may be performed before step S1.

The controller 11 selects one worker to be detected (S3). For example, the controller 11 selects one worker to be detected from a plurality of workers in the worker information 123. The controller 11 may select a worker who should be in an assigned area of a detection target such as a factory at the time when the image is acquired. In this case, the worker information 123 may include information indicating time at which each worker should be in the assigned area of the detection target.

Next, the controller 11 assigns identification information for identifying the worker to the worker selected in step S3 (S4). As the identification information, identification information associated with each worker in the worker information 123 may be used.

The controller 11 executes work classification processing (S5). Details of the work classification processing S5 will be described later.

The controller 11 then determines whether there is another worker to be detected (S6). When there is another worker to be detected (Yes in S6), the controller 11 executes steps S3 to S5 for one of the other workers. In this case, in step S3, the controller 11 selects one of the other workers as one worker to be detected.

When there is no other worker to be detected (No in S6), the controller 11 calculates work time of each worker based on the result of the work classification processing S5 (S7).

The controller 11 causes the display 4 to display at least one of the result of the work classification processing S5 or the calculation result of step S7 via the output interface 14 (S8).

The user 3 can know the content of the action of the worker by viewing the work classification result displayed on the display 4. For example, the user 3 can evaluate the work content of each worker based on such knowledge. By feeding back such evaluation to the worker himself/herself, a labor system, or the like, it is possible to improve the efficiency of the work performed in the workplace 6.

### 1-3-3. Work Classification Processing

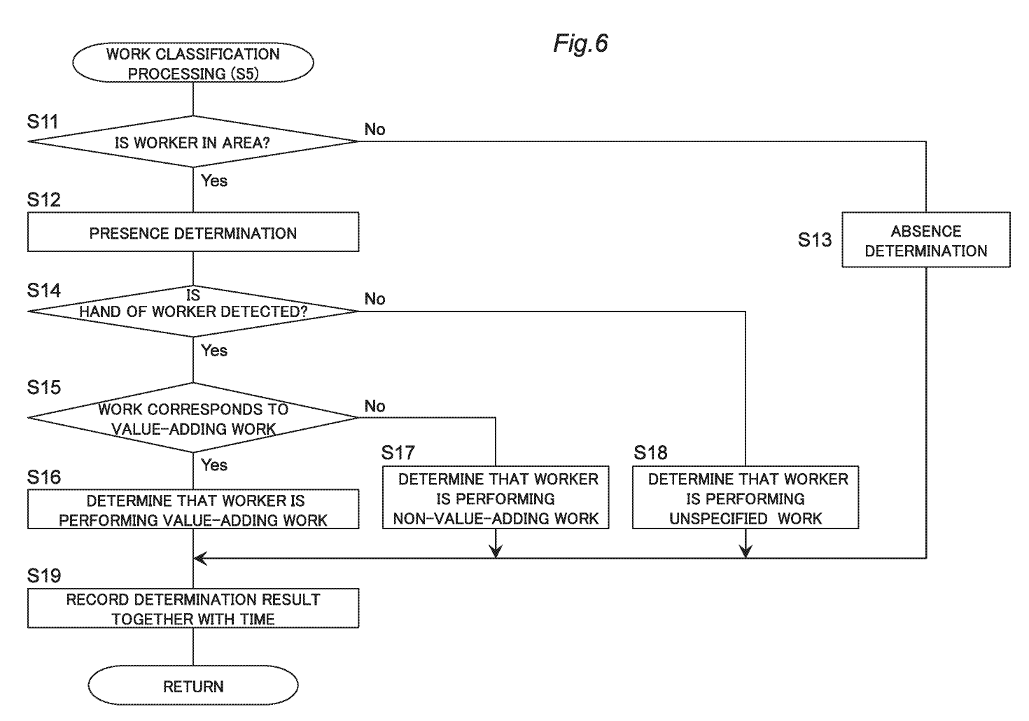

FIG. 6 is a flowchart showing details of the work classification processing S5 illustrated in FIG. 5.

The controller 11 detects whether the worker selected in step S3 in FIG. 5 is in the assigned area of the worker in the image (S11). The assigned area of the worker is determined in advance as a predetermined region in the image, for example. The worker is detected by, for example, a known technique of detecting a person in an image.

In response to detecting that the worker is in the assigned area (Yes in S11), the controller 11 determines that the worker is present in the area (presence determination) (S12).

In response to determining that the worker is not detected in the assigned area (No in S11), the controller 11 determines that the worker is absent (absence determination) (S13). In this example, the absence of the worker means that the worker is not in the assigned area.

Subsequently to step S12, the controller 11 determines whether a hand of the worker is detected (S14). For example, the controller 11 determines whether a hand is detected in the assigned area of the worker in the image.

In the present embodiment, a hand of the worker refers to a portion beyond (distal to) the wrist of the worker. In a case where the worker wears a glove, the hand of the worker in the present embodiment includes the glove. That is, when the worker wears a glove, the controller 11 may determine that the hand of the worker is detected when the glove of the worker is detected.

In response to detecting a hand of the worker (Yes in S14), the controller 11 detects whether the work performed by the worker in the image corresponds to the value-adding work (S15).

At least one of the processing in step S14 or S15 is executed by, for example, the detection unit 111 of the controller 11. For example, the detection unit 111 executes at least one of the processing of step S14 or S15 by the work detection model 113.

In response to detecting that the work performed by the worker is the value-adding work (Yes in S15), the controller 11 determines that the worker is performing the value-adding work (S16).

In response to not detecting that the work performed by the worker is the value-adding work (No in S15), the controller 11 determines that the worker is performing the non-value-adding work (S17).

In response to not detecting a hand of the worker in step S14 (No in S14), the controller 11 determines that the worker is performing unspecified work (S18).

In this specification, the expression “the worker is engaged in an unspecified work” refers to a state in which the worker is at least present in the assigned area. The case where the worker is performing the unspecified work includes a case where the worker is performing the value-adding work and a case where the worker is performing the non-value-adding work. The case where the controller 11 determines that the worker is performing the unspecified work means a case where the controller 11 cannot detect a hand of the worker (No in S14) and thus cannot determine whether the worker is performing the value-adding work.

Steps S12, S13, and S16 to S18 described above are executed by the determination unit 112 of the controller 11, for example.

The presence determination defined in step S12 is an example of classifying an action of the worker into a first class. The absence determination defined in step S13 is an example of classifying an action of the worker into a second class.

The value-adding work determination defined in step S16 is an example of classifying an action of the worker into a first subclass. The non-value-adding work determination defined in step S17 is an example of classifying an action of the worker into a second subclass. Each of the first and second subclasses is a subclass obtained by further classifying the first class. In an example, the first subclass is the value-adding work and the second subclass is the non-value-adding work.

After steps S13 and S16 to S18, the controller 11 records the determination result together with the time in the classification result DB 122 (S19).

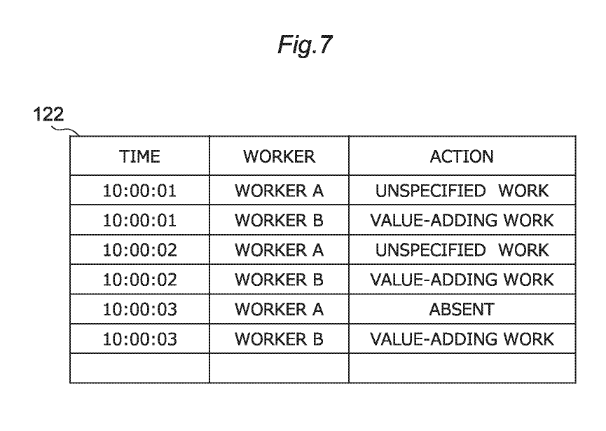

FIG. 7 is a table illustrating an example of the classification result DB 122. In the classification result DB 122 of FIG. 7, the identification information of the worker and a motion content as a result of the work classification processing S5 are associated with time information. The time indicated by the time information corresponds to time at which the image to be processed in the work classification processing S5 is captured.

The example of the classification result DB 122 in FIG. 7 indicates that a worker A is performing the unspecified work at 10:00:01 and 10:00:02 on a specific day and is absent at 10:00:03. The example of the classification result DB 122 in FIG. 7 indicates that a worker B has been performing the value-adding work from 10:00:01 to 10:00:03 on the same day.

By recording a work state of the worker at a predetermined cycle as illustrated in FIG. 7, the controller 11 can aggregate unspecified work time, the value-adding work time, the non-value-adding work time, and/or the time during which the worker is absent (absence time). Since the worker is present in the assigned area during the unspecified work, the value-adding work, and the non-value-adding work, the unspecified work time, the value-adding work time, and the non-value-adding work time may be collectively referred to as “presence time” in this specification.

The presence time, the absence time, the value-adding work time, and the non-value-adding work time are examples of first to fourth times of the present disclosure, respectively. The unspecified work time is an example of a fifth time of the present disclosure.

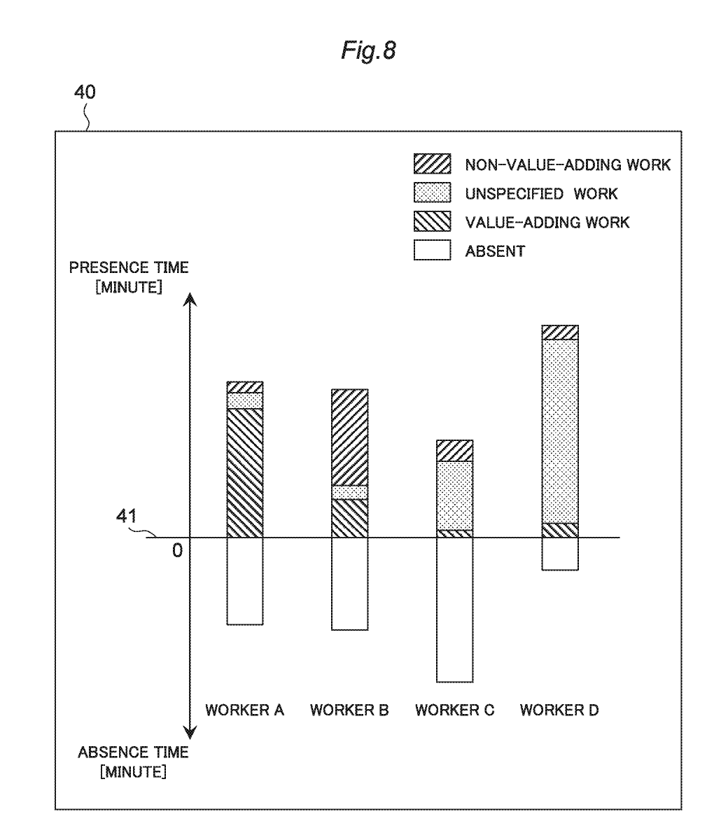

A display example of the classification results such as the presence time and the absence time of the worker aggregated in this manner will be described with reference to FIG. 8.

### 1-4. Display Example

FIG. 8 is a schematic diagram illustrating an example of a display image 40 illustrating a classification result by the work classification processing S5. The display image 40 in FIG. 8 is displayed on the display 4 in step S8 in FIG. 5.

In the display image 40, a bar graph for visualizing the classification result by the work classification processing S5 is shown. The bar graph in FIG. 8 indicates a total value of the unspecified work time, the absence time, the value-adding work time, and the non-value-adding work time of each worker on a specific day. The total value can be calculated by using the classification result DB 122 illustrated in FIG. 7.

In the example of the bar graph illustrated in FIG. 8, the presence time, that is, the value-adding work time, the unspecified work time, and the non-value-adding work time are stacked upward with reference to a reference axis 41. On the other hand, the absence time is indicated by a bar graph extending downward with reference to the reference axis 41. This makes it easy for the user 3 to compare the absence time of each worker, compare the absence time with the presence time of each worker, and the like.

The bar graphs illustrated in FIG. 8 show an example in which the assigned area of the workers A and B is an area in which a hand easily appears, such as the areas 31 and 32 in FIG. 2. Therefore, in the bar graphs of the workers A and B, a ratio of the unspecified work time to the value-adding work time and the non-value-adding work time is small.

On the other hand, the bar graphs illustrated in FIG. 8 show an example in which the assigned area of the workers C and D is an area in which a hand is not likely to appear, such as the area 33 in FIG. 2. Therefore, in the bar graphs of the workers C and D, a ratio of the unspecified work time to the value-adding work time and the non-value-adding work time is larger than that in the bar graphs of the workers A and B.

In the bar graph illustrated in FIG. 8, it can be seen that the absence times of the workers A and B are the same, but the value-adding work time of the worker A is longer than that of the worker B.

In the bar graph illustrated in FIG. 8, it can be seen that the absence time of the worker C is longer than that of the others, and the absence time of the worker D is shorter than that of the others. It can be seen that a ratio of the absence time of the worker C to a total of the presence time (unspecified work time, value-adding work time, and non-value-adding work time) of the worker C is also larger than that of the others. It can be seen that a ratio of the absence time of the worker C to a total of the presence time of the worker D is smaller than that of the others.

The user 3 can analyze the work content of the worker as described above by viewing the display image 40 displayed on the display 4. The user 3 can evaluate the work content of each worker based on a result of such an analysis. By feeding back such evaluation to the worker himself/herself, a labor system, or the like, the user 3 can improve the efficiency of the work performed in the workplace 6. The user 3 can improve the efficiency of the work performed in the workplace 6 by reviewing the system such as the arrangement of things and the arrangement of people in the workplace 6 based on the result of the analysis as described above.

### 1-5. Effects, etc.

As described above, the work classification device 10 according to the present embodiment, that is an example of an image recognition device, includes the storage 12 and the controller 11 that is an example of arithmetic circuitry. The storage 12 stores image data obtained by capturing an image of a work area that is an example of an image of a work region. The controller 11 classifies the action of the worker based on the image data. The classification includes a first class, a second class different from the first class, a first subclass and a second subclass included in the first class. The second subclass is different from the first subclass. The controller 11 switches a granularity of the first class when assigning the action of the worker to the above classification, based on the information in the work region in the image 20 indicated by the image data. For example, the controller 11 switches a classification category of the action of the worker between the first and second classes and the first and second subclasses (S5).

In this configuration, the work classification device 10 can effectively classify the content of the action of the worker in accordance with the imaging situation of the image data. In the following aspect, the work classification device 10 also achieves at least a similar effect.

The controller 11 may determine whether the worker is in the work region in the image 20 (S11). In response to determining that the worker is in the work region in the image 20 (Yes in S11), the controller 11 classifies the action into the first class (S12). In response to determining that the worker is not in the work region in the image 20 (No in S11), the controller 11 classifies the action into the second class (S13).

In response to determining that the worker is in the work region in the image 20 (Yes in S11), the controller 11 may detect a hand of the worker, which is an example of a predetermined object related to the work performed by the worker, in the image 20 (S14). In response to detecting a hand of the worker (Yes in S14), the controller 11 determines whether the work is the value-adding work as a predetermined target work (S15). In response to determining that the work is the value-adding work (Yes in S15), the controller 11 classifies the action into the first subclass (S16). In response to determining that the work is not the value-adding work (No in S15), the controller 11 classifies the action into the second subclass (S17).

In this configuration, when a hand of the worker is detected, the action of the worker can be more finely classified.

In response to determining that a hand of the worker is not detected (No in S14), the controller 11 may classify the action into a class different from all of the second class, the first subclass, and the second subclass. In this configuration, even in a case where a hand of the worker is not detected, the action content of the worker can be classified with the highest possible granularity.

In the image 20, the controller 11 may measure the first time during which the worker performs the action classified into the first class and the second time during which the worker performs the action classified into the second class (S7). By measuring the time corresponding to each classification, for example, the user 3 can quantitatively know the content of the action of the worker.

In the image 20, the controller 11 may measure the third time during which the worker performs the action classified into the first subclass and the fourth time during which the worker performs the action classified into the second subclass.

The work classification device 10 may further include the output interface 14 that is an example of an output unit that outputs information to the display 4. The controller 11 may cause the display 4 to display data indicating the classification result of the action via the output interface 14.

The controller 11 may cause the display 4 to display information indicating the first time and the second time via the output interface 14. The controller 11 may cause the display 4 to display information indicating the first to fourth times via the output interface 14.

The user 3 can analyze the work content of the worker by viewing the data displayed on the display 4. The user 3 can evaluate the work content of each worker based on a result of such an analysis. By feeding back such evaluation to the worker himself/herself, a labor system, or the like, the user 3 can improve the efficiency of the work performed in the workplace 6. The user 3 can improve the efficiency of the work performed in the workplace 6 by reviewing the system such as the arrangement of things and the arrangement of people in the workplace 6 based on the result of the analysis as described above.

### 2. Second Embodiment

In the first embodiment, an example in which the object is a hand of a worker is described, but in the second embodiment, an example in which the object is a lamp will be described.

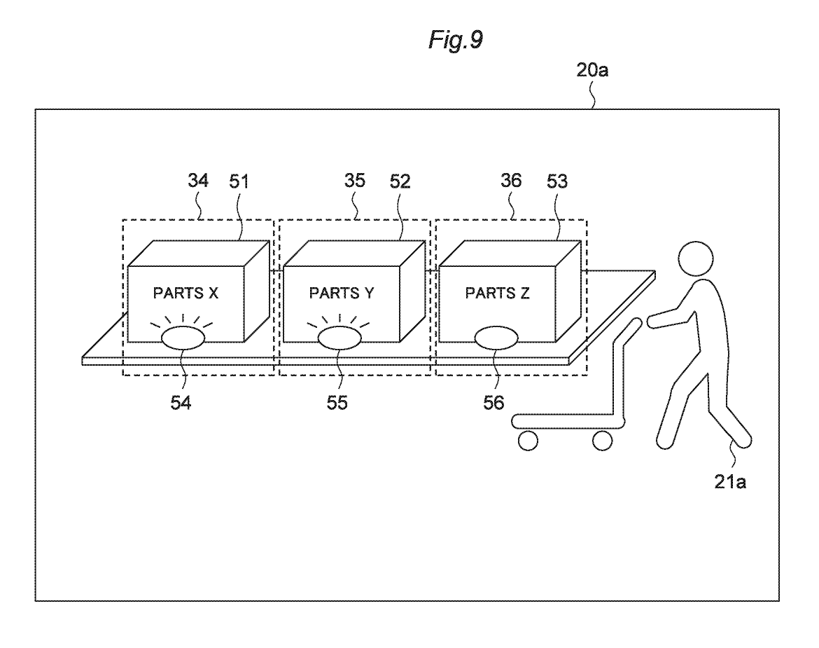

FIG. 9 is a schematic diagram illustrating an example of an image 20a indicated by image data generated by the camera 2 in the second embodiment. The image 20a shows a worker 21a who performs work in the workplace.

Three boxes 51 to 53 are disposed in the workplace. The boxes 51 to 53 accommodate parts X, Y, and Z, respectively. In the present embodiment, the worker 21a extracts the parts X, Y, and Z from the boxes 51 to 53 and carries the parts extracted to a predetermined place for shipment.

FIG. 9 illustrates three work areas 34 to 36. For example, the work areas 34 to 36 are determined in advance as predetermined regions in the image 20a. In the example in FIG. 9, the work areas 34 to 36 are regions corresponding to the boxes 51 to 53, respectively. For example, a positional relationship between the work area 34 and the box 51 is configured such that the worker 21a enters the work area 34 in the image 20a when the worker 21a stands in front of the box 51. The same applies to a positional relationship between the work area 35 and the box 52 and a positional relationship between the work area 36 and the box 53.

Lamps 54 to 56 are disposed in front of the boxes 51 to 53 (between the boxes 51 to 53 and the camera 2), respectively. The lamps 54 to 56 are configured to be turned on before the worker 21a performs work. When the worker 21a extracts the part X from the box 51, the lamp 54 corresponding to the box 51 is turned off. Similarly, when the worker 21a extracts the part Y from the box 52, the lamp 55 is turned off, and when the worker 21a extracts the part X from the box 53, the lamp 56 is turned off.

In the present embodiment, when the worker 21a is in front of a box at which the corresponding lamp is turned on, the controller 11 determines that the worker 21a is performing the value-adding work. The value-adding work assumed in the present embodiment is work in which the worker 21a extracts a part from a box at which a corresponding lamp is turned on.

In the present embodiment, when the worker 21a is in front of a box at which the corresponding lamp is turned off, the controller 11 determines that the worker 21a is performing the non-value-adding work. The non-value-adding work assumed in the present embodiment is work other than the work of extracting a part, for example, arrangement work.

In the present embodiment, when the corresponding lamp is not shown in the image 20a, the controller 11 determines that the worker 21a is performing the unspecified work. In a case where the worker 21a is not in front of the box, the controller 11 determines that the worker 21a is absent.

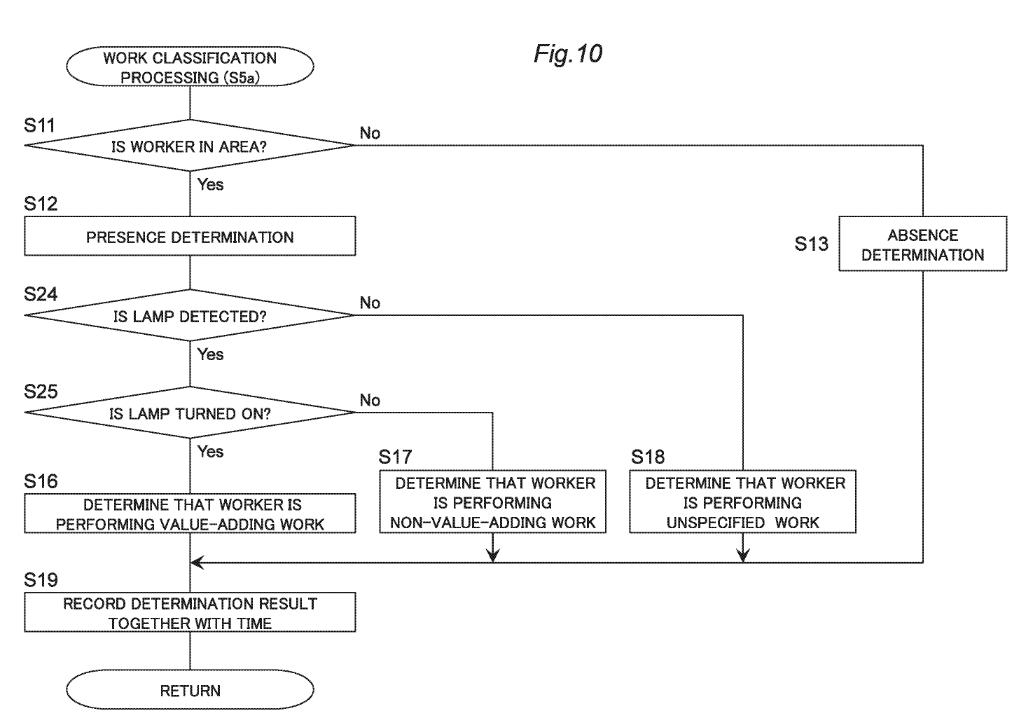

FIG. 10 is a flowchart illustrating an example of work classification processing S5a according to the present embodiment. In the present embodiment, the controller 11 executes the work classification processing S5a in FIG. 10 instead of the work classification processing S5 according to the first embodiment.

As compared with the work classification processing S5 according to the first embodiment illustrated in FIG. 6, the work classification processing S5a in FIG. 10 includes step S24 instead of step S14, and includes step S25 instead of step S15.

In the work classification processing S5a in FIG. 10, the controller 11 first detects whether the worker 21a is in the work area in the image (S11). In the present embodiment, the work areas 34 to 36 are regions in front of the boxes 51 to 53 (between the boxes 51 to 53 and the camera 2).

In response to detecting that the worker 21a is in the work area (Yes in S11), the controller 11 determines that the worker is present in the work area (presence determination) (S12). In response to not detecting that the worker is in the work area (No in S11), the controller 11 determines that the worker is absent (absence determination) (S13).

Subsequently to step S12, the controller 11 determines whether a lamp is detected (S24). In the example in FIG. 9, the controller 11 determines whether any of the lamps 54 to 56 are detected.

In response to detecting a lamp (Yes in S24), the controller 11 detects whether the lamp is turned on (S25). In the present embodiment, detecting whether the lamp is turned on is an example of detecting whether the work performed by the worker in the image is the value-adding work.

In response to detecting that the lamp is turned on (Yes in S25), the controller 11 determines that the worker is performing the value-adding work (S16). In response to not detecting that the lamp is turned on (No in S25), the controller 11 determines that the worker is performing the non-value-adding work (S17).

In response to not detecting a lamp in step S24 (No in S24), the controller 11 determines that the worker is performing unspecified work (S18).

In the present embodiment, the work classification device 10 can also effectively classify the content of the action of the worker in accordance with the imaging situation of the image data.

### 3. Other Embodiments

As described above, the embodiments have been described as examples of the technique in the present disclosure. However, the technique in the present disclosure is not limited to the embodiments, and is also applicable to the embodiment in which changes, replacements, additions, omissions, or the like are appropriately made. It is also possible to combine the constituent elements described in each of the embodiments to form a new embodiment. Therefore, other embodiments will be exemplified below.

In the first embodiment, an example is described in which the object is a hand of the worker and the target work includes the motion of the hand. The present disclosure is not limited to this example, and the object may be a foot of a worker. In this case, the target work may include a motion of a foot. The object may be a part of an arbitrary body of the worker, or may be a tool or the like used by the worker for work.

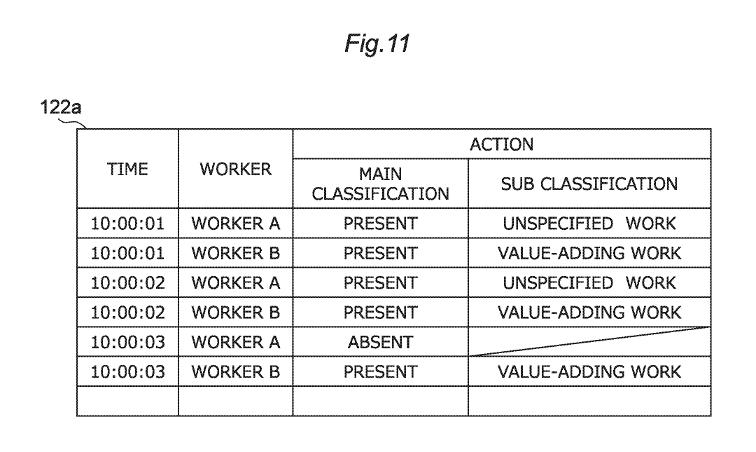

In FIG. 7 of the first embodiment, the example of the classification result DB 122 including only the unspecified work time, the value-adding work time, and the non-value-adding work time as the contents of the motion of the worker is described, but the classification result DB is not limited to this example. FIG. 11 is a table illustrating an example of a modification of a classification result DB 122a.

In a classification result DB 122a in FIG. 11, the content of the motion of the worker is classified into presence (first class) or absence (second class) as a main classification. In a case where the main classification is presence (first class), the content of the motion of the worker is further classified as sub-classification (subclass), that is, during the value-adding work (first subclass), during the non-value-adding work (second subclass), or during the unspecified work.

In the first embodiment, an example is described in which the controller 11 executes step S3 for selecting one worker to be detected from the image indicated by the image data 121, but the present disclosure is not limited to this example. For example, a specific work area and a specific worker may be associated in advance. In this case, step S3 may be omitted. For example, when the work area is specified, the controller 11 can specify the worker associated with the work area. In this case, even if the worker associated with the work area is not shown in the work area in the image indicated by the image data 121, the worker associated with the work area can be specified.

In a case where a specific work area and a specific worker are associated in advance as described above, the controller 11 can identify the worker associated with the work area when the work area is identified. Therefore, in this case, step S4 in FIG. 5 may be omitted.

### 4. Example of Aspects

Hereinafter, various aspects according to the present disclosure will be listed.

### Aspect 1

An image recognition device comprising: a memory that stores image data in which an image of a work region is captured by a camera; and arithmetic circuitry that performs a classification of an action of a worker based on the image data, wherein the classification includes a first class, a second class different from the first class, a first subclass and a second subclass included in the first class, the second subclass being different from the first subclass, and the arithmetic circuitry switches a granularity of the first class when assigning the action of the worker to the classification, based on information in the work region in the image indicated by the image data.

### Aspect 2

The image recognition device according to Aspect 1, wherein the arithmetic circuitry determines whether the worker is in the work region in the image, in response to determining that the worker is in the work region in the image, the arithmetic circuitry classifies the action into the first class, and in response to determining that the worker is not in the work region in the image, the arithmetic circuitry classifies the action into the second class.

### Aspect 3

The image recognition device according to Aspect 2, wherein in response to determining that the worker is in the work region in the image, the arithmetic circuitry detects an object predetermined and related to work performed by the worker in the image, in response to detecting the object, the arithmetic circuitry determines whether the work is a target work predetermined, and in response to determining that the work is the target work, the arithmetic circuitry classifies the action into the first subclass, and in response to determining that the work is not the target work, the arithmetic circuitry classifies the action into the second subclass.

### Aspect 4

The image recognition device according to Aspect 3, wherein in response to determining that the object is not detected, the arithmetic circuitry classifies the action into a class different from any of the second class, the first subclass, and the second subclass.

### Aspect 5

The image recognition device according to any one of Aspect 1 to 4, wherein the arithmetic circuitry measures: a first time during which the worker performs the action classified into the first class in the image; and a second time during which the worker performs the action classified into the second class in the image.

### Aspect 6

The image recognition device according to Aspect 5, wherein the arithmetic circuitry measures: a third time during which the worker performs the action classified into the first subclass in the image; and a fourth time during which the worker performs the action classified into the second subclass in the image.

### Aspect 7

The image recognition device according to any one of Aspect 1 to 6, further comprising an output interface that outputs information to a display, wherein the arithmetic circuitry causes the display to display data indicating a classification result of the action via the output interface.

### Aspect 8

The image recognition device according to Aspect 5, further comprising an output interface that outputs information to a display, wherein the arithmetic circuitry causes the display to display information indicating the first time and the second time via the output interface.

### Aspect 9

The image recognition device according to Aspect 6, further comprising an output interface that outputs information to a display, wherein the arithmetic circuitry causes the display to display information indicating the first to fourth times via the output unit.

### Aspect 10

The image recognition device according to Aspect 3 or 4, wherein the object is a hand of the worker, and the target work includes a motion of the hand.

### Aspect 11

The image recognition device according to Aspect 3 or 4, wherein the object is a foot of the worker, and the target work includes a motion of the foot.

### Aspect 12

The image recognition device according to Aspect 3 or 4, wherein the object is a lamp installed in a work region, and the arithmetic circuitry detects whether the lamp is turned on based on the image data, and in response to detecting that the lamp is turned on, the arithmetic circuitry determines that the work is the target work.

### Aspect 13

An image recognition method for performing a classification of an action of a worker, the method comprising: acquiring, by arithmetic circuitry, image data in which an image of a work region is captured by a camera; performing, by the arithmetic circuitry, a classification of an action of the worker based on the image data, wherein the classification includes a first class, a second class different from the first class, a first subclass and a second subclass included in the first class, the second subclass being different from the first subclass, and wherein the method further comprising switching, by the arithmetic circuitry, a granularity of the first class when assigning the action of the worker to the classification, based on information in the work region in the image indicated by the image data.

### Aspect 14

A non-transitory computer-readable storage medium storing a program for causing arithmetic circuitry to execute the image recognition method according to Aspect 13.

What is claimed is:

1. An image recognition device comprising:
a memory that stores image data in which an image of a work region is captured by a camera; and
arithmetic circuitry that performs a classification of an action of a worker based on the image data, wherein
the classification includes a first class, a second class different from the first class, a first subclass and a second subclass included in the first class, the second subclass being different from the first subclass, and
the arithmetic circuitry switches a granularity of the first class when assigning the action of the worker to the classification, based on information in the work region in the image indicated by the image data.

2. The image recognition device according to claim 1, wherein
the arithmetic circuitry determines whether the worker is in the work region in the image,
in response to determining that the worker is in the work region in the image, the arithmetic circuitry classifies the action into the first class, and
in response to determining that the worker is not in the work region in the image, the arithmetic circuitry classifies the action into the second class.

3. The image recognition device according to claim 2, wherein
in response to determining that the worker is in the work region in the image, the arithmetic circuitry detects an object predetermined and related to work performed by the worker in the image,
in response to detecting the object, the arithmetic circuitry determines whether the work is a target work predetermined, and
in response to determining that the work is the target work, the arithmetic circuitry classifies the action into the first subclass, and
in response to determining that the work is not the target work, the arithmetic circuitry classifies the action into the second subclass.

4. The image recognition device according to claim 3, wherein in response to determining that the object is not detected, the arithmetic circuitry classifies the action into a class different from any of the second class, the first subclass, and the second subclass.

5. The image recognition device according to claim 1, wherein
the arithmetic circuitry measures:
a first time during which the worker performs the action classified into the first class in the image; and
a second time during which the worker performs the action classified into the second class in the image.

6. The image recognition device according to claim 5, wherein
the arithmetic circuitry measures:
a third time during which the worker performs the action classified into the first subclass in the image; and
a fourth time during which the worker performs the action classified into the second subclass in the image.

7. The image recognition device according to claim 1, further comprising an output interface that outputs information to a display, wherein
the arithmetic circuitry causes the display to display data indicating a classification result of the action via the output interface.

8. The image recognition device according to claim 5, further comprising an output interface that outputs information to a display, wherein
the arithmetic circuitry causes the display to display information indicating the first time and the second time via the output interface.

9. The image recognition device according to claim 6, further comprising an output interface that outputs information to a display, wherein
the arithmetic circuitry causes the display to display information indicating the first to fourth times via the output unit.

10. The image recognition device according to claim 3, wherein
the object is a hand of the worker, and
the target work includes a motion of the hand.

11. The image recognition device according to claim 3, wherein
the object is a foot of the worker, and
the target work includes a motion of the foot.

12. The image recognition device according to claim 3, wherein
the object is a lamp installed in a work region, and
the arithmetic circuitry detects whether the lamp is turned on based on the image data, and
in response to detecting that the lamp is turned on, the arithmetic circuitry determines that the work is the target work.

13. An image recognition method for performing a classification of an action of a worker, the method comprising:
acquiring, by arithmetic circuitry, image data in which an image of a work region is captured by a camera;
performing, by the arithmetic circuitry, a classification of an action of the worker based on the image data, wherein
the classification includes a first class, a second class different from the first class, a first subclass and a second subclass included in the first class, the second subclass being different from the first subclass, and wherein
the method further comprising switching, by the arithmetic circuitry, a granularity of the first class when assigning the action of the worker to the classification, based on information in the work region in the image indicated by the image data.

14. A non-transitory computer-readable storage medium storing a program for causing arithmetic circuitry to execute the image recognition method according to claim 13.
